(19) United States
(12) Patent Application Publication
(10) Pub. No.: US 2017/0171106 A1
(43) Pub. Date: Jun. 15, 2017

(54) QUALITY OF SERVICE MANAGEMENT METHOD IN FABRIC NETWORK AND FABRIC NETWORK SYSTEM USING THE SAME

(71) Applicant: SAMSUNG ELECTRONICS CO., LTD., Suwon-si (KR)

(72) Inventors: Jung-hyo WOO, Seoul (KR); Ji-hyung PARK, Yongin-si (KR); Hyun-joo MAENG, Goyang-si (KR); I-saac BAEK, Hwaseong-si (KR)

(73) Assignee: SAMSUNG ELECTRONICS CO., LTD., Suwon-si (KR)

(21) Appl. No.: 15/298,803

(22) Filed: Oct. 20, 2016

(30) Foreign Application Priority Data
Dec. 15, 2015 (KR) 10-2015-0179198

(51) Int. Cl. H04L 12/927; H04L 12/26; H04L 29/08

(52) U.S. Cl. CPC H04L 47/805; H04L 67/1097; H04L 43/08

(57) ABSTRACT

A quality of service (QoS) management method in a fabric network and a fabric network system using the same are provided. The QoS management method in the fabric network includes receiving QoS information from a host via the fabric network, and allocating one or more storage devices corresponding to the QoS information received from the host to the host by using a performance table which is initially set with respect to storage devices.

### CROSS-REFERENCE TO RELATED APPLICATION

This application claims priority from Korean Patent Application No. 10-2015-0179198, filed on Dec. 15, 2015, in the Korean Intellectual Property Office, the disclosure of which is incorporated by reference herein in its entirety.

### BACKGROUND

Systems, apparatuses, and methods consistent with the present disclosure relate to a fabric network system and a device using the fabric network, and more particularly, to a quality of service (QoS) management method in a fabric network and a fabric network system using the same.

In general, in a storage system included in a fabric network, a storage device is allocated according to a capacity required by a host, irrespective of an interface bandwidth of the storage device. Accordingly, in terms of QoS, unnecessarily high performance may be provided to a host, or the performance required by the host may not be met by the storage device.

### SUMMARY

One or more example embodiments provide a quality of service (QoS) management method in a fabric network, whereby QoS is efficiently managed by using a performance table in the fabric network.

One or more example embodiments also provide a fabric network system whereby QoS is efficiently managed by using a performance table in the fabric network.

According to an aspect of an exemplary embodiment, there is provided a quality of service (QoS) management method in a fabric network, the method including receiving QoS information from a host via the fabric network, and allocating one or more storage devices corresponding to the QoS information received from the host to the host by using a performance table which is initially set with respect to storage devices.

According to an aspect of another exemplary embodiment, there is provided a fabric network system including a fabric network device comprising a plurality of ports and configured to support communication between a host linked to one or more of the ports and storage devices linked to one or more of the ports; a memory configured to store a performance table configured to represent an interface performance of an interface based on an interface bandwidth of the interface, the number of storage devices connected to the interface, and a queue depth of the interface; and a controller configured to receive quality of service (QoS) information from the host and to allocate one or more storage devices corresponding to the received QoS information to the host by using the performance table.

According to an aspect of another exemplary embodiment, there is provided a fabric network system including a fabric network device comprising a plurality of ports; a memory configured to store a performance table that includes interface performance information set in advance for each of a plurality of storage devices; and a controller configured to receive quality of service (QoS) information from a host coupled to a port, and to allocate one or more storage devices coupled to one or more of the ports using the received QoS information of the host and the interface performance information of the storage devices included in the performance table.

### BRIEF DESCRIPTION OF THE DRAWINGS

Example embodiments will be more clearly understood from the following detailed description taken in conjunction with the accompanying drawings in which:

FIG. 1A is an example of a structure of a fabric network system, according to an example embodiment;

FIG. 1B is another example of a structure of a fabric network system, according to an example embodiment;

FIG. 2 is an example of a detailed structure of a fabric network device illustrated in FIGS. 1A and 1B;

FIG. 3A is an example of a structure of a computing system implementing a fabric network system, according to an example embodiment;

FIG. 3B is another example of a structure of a computing system implementing a fabric network system, according to an example embodiment;

FIG. 3C is another example of a structure of a computing system implementing a fabric network system, according to an example embodiment;

FIG. 3D is another example of a structure of a computing system implementing a fabric network system, according to an example embodiment;

FIG. 4A is a view for describing an example of a method in which quality of service (QoS) is managed per an interface bandwidth group of storage devices in a computing system implementing a fabric network system, according to an example embodiment;

FIG. 4B is a view for describing another example of a method in which QoS is managed per an interface bandwidth group of storage devices in a computing system implementing a fabric network system, according to an example embodiment;

FIG. 5 is a view of a structure of a host illustrated in FIGS. 3A through 3D, according to an example embodiment;

FIG. 6 is a view of a structure of a storage device illustrated in FIGS. 3A through 3D, according to an example embodiment;

FIG. 7 is a view of a structure of a memory controller of the storage device illustrated in FIG. 6, according to an example embodiment;

FIG. 8 is an example of a detailed structure of the memory device of the storage device illustrated in FIG. 6;

FIG. 9 is an example of a memory cell array of the memory device illustrated in FIG. 8;

FIG. 10 is a circuit diagram of an example of a first memory block included in the memory cell array illustrated in FIG. 9;

FIG. 11 is a flowchart of an example of a QoS management method in a fabric network, according to an example embodiment;

FIG. 12 is a flowchart of another example of a QoS management method in a fabric network, according to an example embodiment; and

FIG. 13 is a flowchart of another example of a QoS management method in a fabric network, according to an example embodiment.

### DETAILED DESCRIPTION OF EXAMPLE EMBODIMENTS

Hereinafter, example embodiments will now be described more fully with reference to the accompanying drawings. Like reference numerals in the drawings denote like elements, and a repeated explanation will not be given of overlapping features.

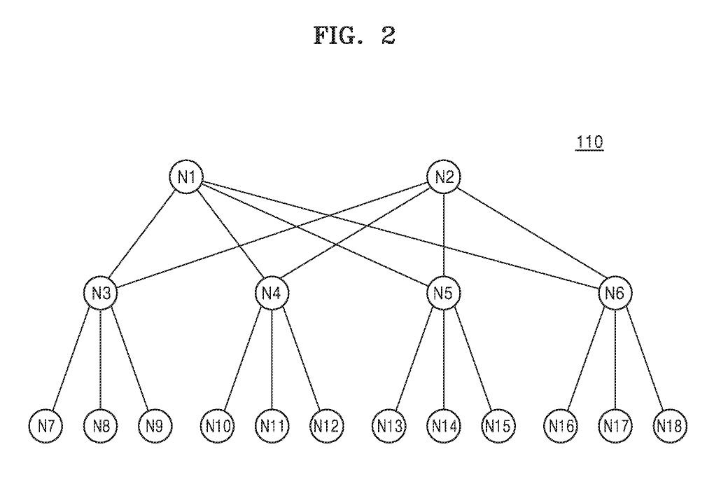

Herein, a fabric network is a network in which network nodes are connected via a plurality of network switches (see, e.g., FIG. 2 discussed later), and has better performance characteristics that broadcast networks such as Ethernet networks.

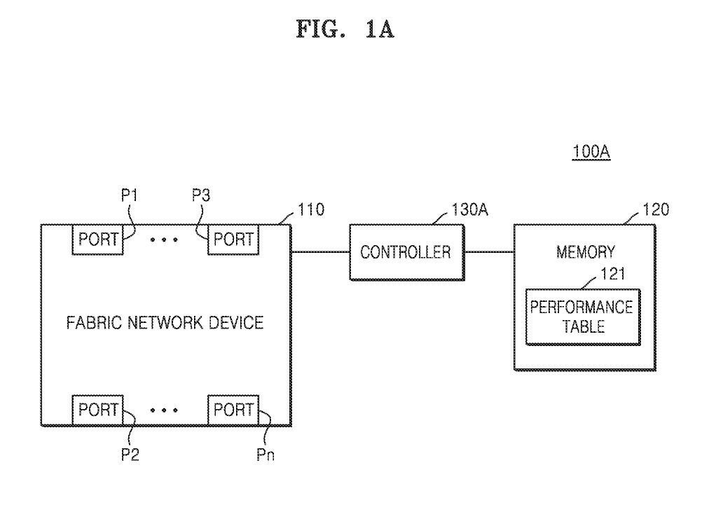

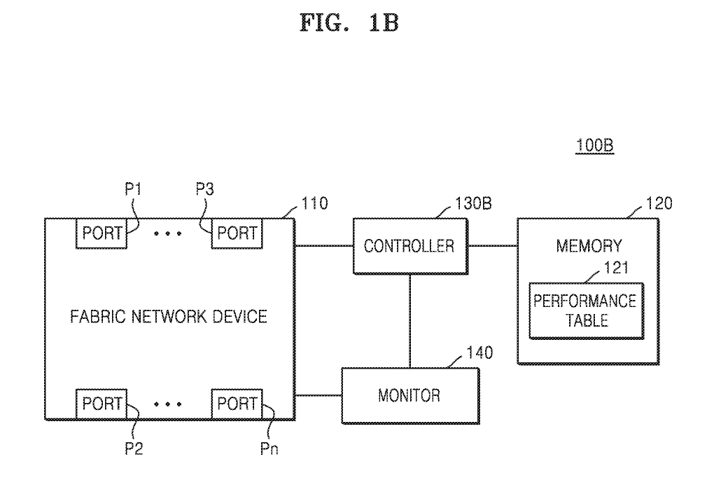

FIG. 1A is an example of a structure of a fabric network system 100A according to an example embodiment.

As illustrated in FIG. 1A, the fabric network system 100A includes a fabric network device 110, a memory 120, and a controller 130A. The controller 130A may include one or more microprocessors.

The fabric network device 110 includes a plurality of ports P1 to Pn and supports communication among devices linked to the ports P1 to Pn. A computer, a set-top box, a server, a digital camera, a navigation device, a mobile device, a storage device, etc. may be linked to one or more of the ports P1 to Pn. For example, one or more hosts may be linked to one or more ports P1 to Pn, and one or more storage devices may be linked to one or more of the ports P1 to Pn.

The fabric network device 110 performs communication connection among the ports P1 to Pn via one or more switching nodes. When there are a plurality of switching nodes, the ports P1 to Pn of the fabric network device 110 may be connected to each other for communication via a plurality of paths.

The memory 120 may include static random access memory (SRAM) or dynamic random access memory (DRAM) for storing data, instructions, or program codes used for an operation of the controller 130A. Also, the memory 120 may include a nonvolatile memory. For example, when the memory 120 includes SRAM or DRAM, which is a volatile memory, the data, instructions, or program codes used for the operation of the controller 130A may be provided and loaded from a storage device.

The memory 120 stores a performance table 121. The performance table 121 may be configured to represent an interface performance based on an interface bandwidth, the number of storage devices, and a queue depth in a fabric network. For example, the performance table 121 may include an input/output (I/O) performance table based on the interface bandwidth, the number of storage devices, and the queue depth in the fabric network. For example, the performance table 121 may include a latency performance table based on the interface bandwidth, the number of storage devices, and the queue depth in the fabric network. For example, the performance table 121 stored in the memory 120 may include the I/O performance table and the latency performance table, which are based on the interface bandwidth, the number of storage devices, and the queue depth in the fabric network. That is, a plurality of performance tables may be stored in the memory 120.

For example, the performance table 121 may be generated per unit of a group of storage devices classified based on an interface bandwidth. For example, the performance table 121 may be determined via simulation or experimental statistics. Alternatively, in some exemplary embodiments, the performance table 121 may be generated per individual storage device based on interface bandwidths of an individual storage device.

The controller 130A controls the fabric network system 100A by using the data, instructions, or program codes stored in the memory 120. For example, the controller 130A allocates one or more storage devices corresponding to quality of service (QoS) required from a host in the fabric network device 110 to the host by using the performance table 121 stored in the memory 120.

For example, when the performance table 121 is stored per unit of a group of storage devices classified based on a bandwidth of the storage devices, the controller 130A may allocate at least one group of storage devices corresponding to the QoS required from the host to the host based on the performance table per unit of the group of storage devices. Alternatively or additionally, the performance table 121 may store bandwidths for individual storage devices, and the controller 130A may allocate a storage device to the host based on the performance table per unit of an individual storage device.

As another example, when the performance table 121 is stored per unit of a group of storage devices classified based on a performance specification of the storage devices, the controller 130A may allocate at least one group of storage devices corresponding to the QoS required from the host to the host based on the performance table per unit of the group of storage devices. Alternatively or additionally, the performance table 121 may store performance specifications for individual storage devices, and the controller 130A may allocate a storage device to the host based on the performance table per unit of an individual storage device.

The fabric network device 110 supports communication between the host and the storage devices based on the allocation of the storage devices to the host via the controller 130A.

FIG. 1B is another example of a structure of a fabric network system 100B according to an example embodiment.

As illustrated in FIG. 1B, the fabric network system 100B includes the fabric network device 110, the memory 120, a controller 130B, and a monitor 140. The controller 130B may include one or more microprocessors. Similarly, the monitor 140 may include one or more microprocessors.

The fabric network device 110 and the memory 120 illustrated in FIG. 1B are substantially the same as the fabric network device 110 and the memory 120 illustrated in FIG. 1A, respectively, and thus, repeated descriptions thereof will not be given.

The monitor 140 monitors an external interface state with respect to a host linked to one or more of the plurality of ports P1 to Pn of the fabric network device 110, and an internal interface state with respect to a storage device linked to one or more of the ports P1 to Pn of the fabric network device 110. According to example embodiments, an interface between the fabric network device 110 and the host is defined as the external interface, and an interface between the fabric network device 110 and the storage device is defined as the internal interface.

For example, the monitor 140 may detect an external interface bandwidth based on external interface bandwidth configuration information received from the host linked to one or more of the ports P1 to Pn of the fabric network device 110. Also, the monitor 140 may detect an internal interface bandwidth based on internal interface bandwidth configuration information received from the storage device linked to one or more of the ports P1 to Pn of the fabric network device 110.

For example, the monitor 140 may monitor an interface performance according to the storage devices allocated to the host in the fabric network device 110. For example, the monitored interface performance may include an I/O bandwidth or a latency.

The controller 130B controls the fabric network system 100B by using data, instructions, or program codes stored in the memory 120. For example, the controller 130B allocates one or more storage devices corresponding to a QoS required from a host in the fabric network device 110 to the host by using the performance table 121 stored in the memory 120.

For example, when the performance table 121 is stored per unit of the group of storage devices classified based on the bandwidth or the performance specification of the storage devices, the controller 130B may allocate at least one group of storage devices corresponding to the QoS required from the host to the host based on the performance table per unit of the group of storage devices. Alternatively or additionally, the performance table 121 may store bandwidths or performance specifications for individual storage devices, and the controller 130A may allocate a storage device to the host based on the performance table per unit of an individual storage device.

The controller 130B updates the performance table 121 stored in the memory based on a result of the monitoring by the monitor 140.

Also, the controller 130B may adjust an interface bandwidth of one or more storage interfaces allocated to the host so that the interface performance monitored by the monitor 140 satisfies the performance of the QoS required from the host. For example, the interface performance may include I/O performance in the fabric network.

The controller 130B receives information with respect to the monitored interface performance from the monitor 140. Also, when the performance based on the information with respect to the monitored interface performance does not satisfy the performance of the QoS required from the host, the controller 130B adjusts the interface bandwidth of one or more storage devices allocated to the host in order to satisfy the performance of the QoS. For example, when a group of storage devices based on the interface bandwidth is allocated to the host, the controller 130B may adjust the interface bandwidth of the group of storage devices. Alternatively or additionally, when an individual storage device based on the interface bandwidth of the individual storage device is allocated to the host, the controller 130B may adjust the interface bandwidth of the individual storage device.

FIG. 2 is an example of a detailed structure of the fabric network device 110 of the fabric network system illustrated in FIG. 1A or 1B.

As illustrated in FIG. 2, the fabric network device 110 may include a plurality of switching nodes N1 to N18. In an example embodiment of FIG. 2, there are eighteen switching nodes N1 to N18. However, the number of switching nodes N1 to N18 may be more or less than 18, by taking into account the number of devices linked to the fabric network device 110.

Each of the switching nodes N1 to N18 includes a fabric switch, and a plurality of paths are inter-connected via each of the switching nodes N1 to N18. The fabric switch included in each of the switching nodes N1 to N18 may control a communication path so that communication among the switching nodes N1 to N18 is performed.

Some or all of the switching nodes N1 to N18 may be allocated to the host or to one or more of the ports P1 to Pn to which the devices are linked.

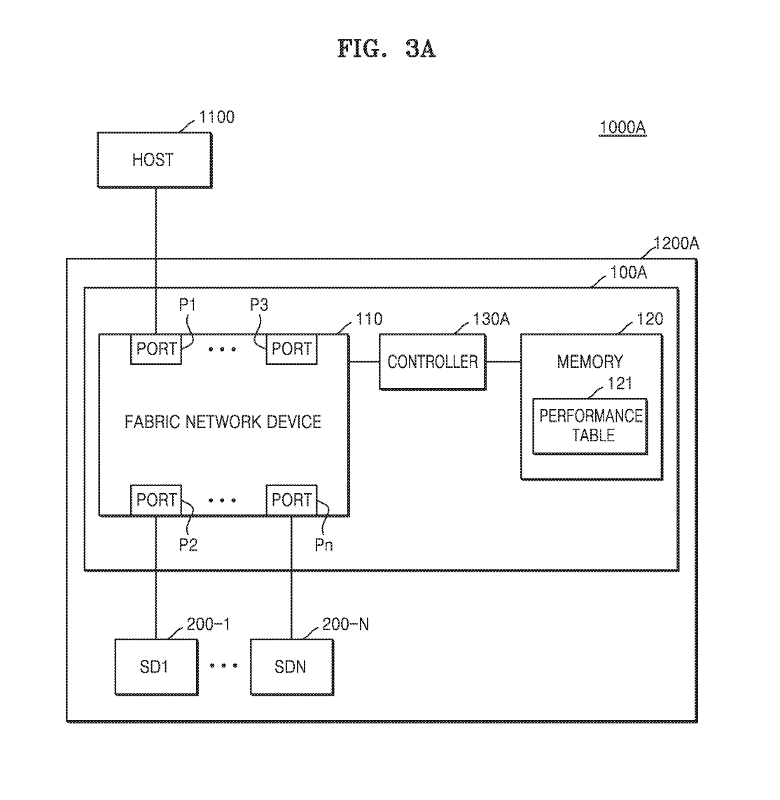

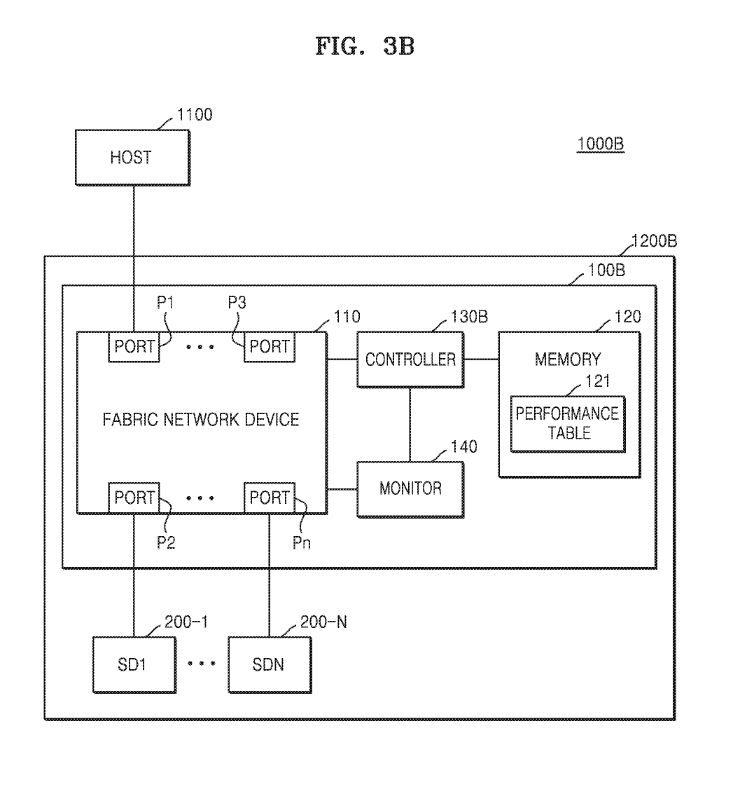

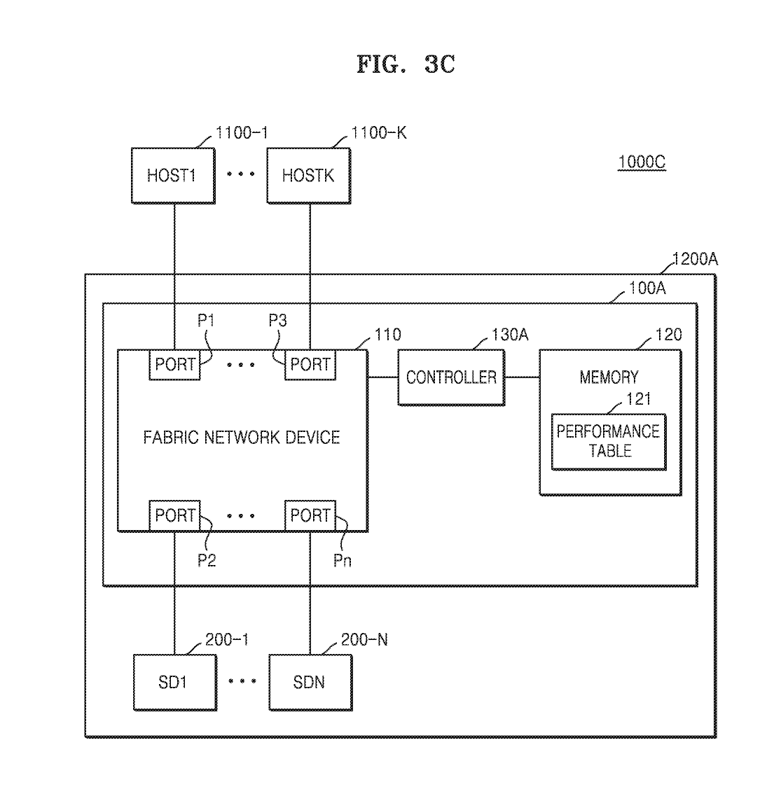

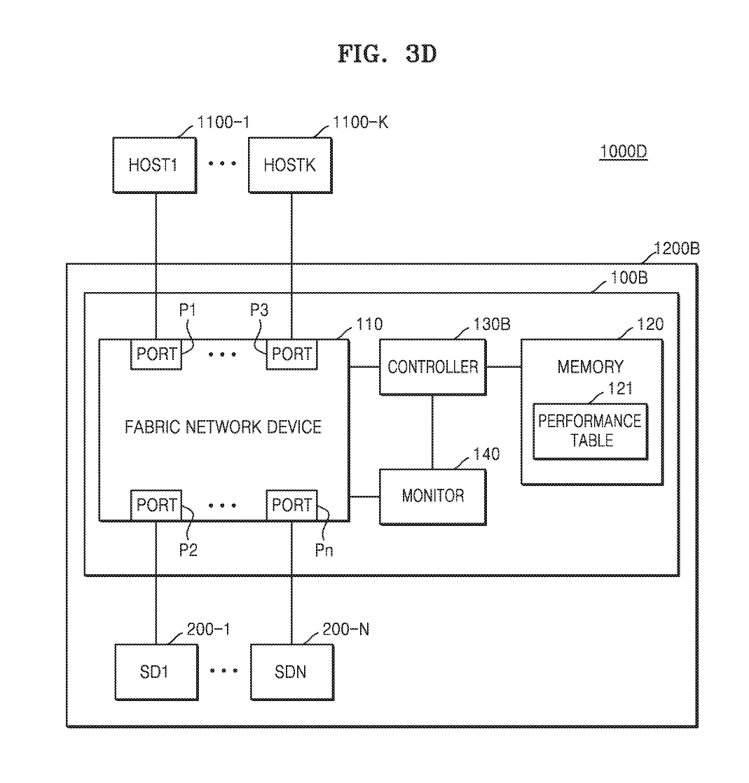

FIG. 3A is an example of a structure of a computing system 1000A using the fabric network system 100A, according to an example embodiment.

As illustrated in FIG. 3A, the computing system 1000A includes a host 1100 and a storage system 1200A. The storage system 1200A includes the fabric network system 100A and a plurality of storage devices, for example storage device SD1 200-1 to storage device SDN 200-N (here, N is an integer that is equal to or greater than 2).

In the example embodiment of FIG. 3A, the fabric network system 100A is included in the storage system 1200A. As another example, the fabric network system 100A may be separated from the storage system 1200A and may have a separate structure. As another example, the fabric network system 100A may be included in the host 1100. The fabric network system 100A has been described with reference to FIGS. 1A, 1B and 2, and thus, repeated descriptions thereof will not be given.

The host 1100 includes hardware and software capable of communicating with the storage devices SD1 to SDN 200-1 to 200-N that are linked to the host 1100 via the fabric network system 100A. Also, the host 1100 may include hardware and software for performing various computational processing operations.

For example, the host 1100 may write data to the storage devices SD1 to SDN 200-1 to 200-N that are linked to the host 1100 via the fabric network system 100A, or read data from the storage devices SD1 to SDN 200-1 to 200-N. Also, the host 1100 may perform various computational processing operations by using the data read from the storage devices SD1 to SDN 200-1 to 200-N.

For example, the host 1100 may provide external interface bandwidth configuration information to the fabric network device 110 in a process of setting communication with the fabric network system 100A. Also, the host 1100 may provide the QoS information required by the host 1100 to the fabric network system 100A.

The storage devices SD1 to SDN 200-1 to 200-N include hardware and software capable of communicating with the host 1100 linked to the storage devices SD1 to SDN 200-1 to 200-N via the fabric network system 100A.

The storage devices SD1 to SDN 200-1 to 200-N include hardware and software for adjusting an internal interface bandwidth for communication with the fabric network system 100A. The fabric network system 100A may adjust the internal interface bandwidth of each of the storage devices SD1 to SDN 200-1 to 200-N. For example, the storage devices SD1 to SDN 200-1 to 200-N may receive a request of adjustment of the internal interface bandwidth via the controller 130A of the fabric network system 100. Then, the storage devices SD1 to SDN 200-1 to 200-N adjust the interface bandwidth of the storage device based on the request of adjustment of the internal interface bandwidth.

For example, each of the storage devices SD1 to SDN 200-1 to 200-N may include a solid state drive (SSD). As another example, each of the storage devices SD1 to SDN 200-1 to 200-N may include a hard disk drive (HDD). As another example, the storage devices SD1 to SDN 200-1 to 200-N may include one or more SSDs and one or more HDDs.

An interface configured to connect the host 1100 and the storage devices SD1 to SDN 200-1 to 200-N may include various interfaces, such as a peripheral component interconnect express (PCIe) interface, a serial attached small computer system (SAS) interface, a serial advanced technology attachment (SATA) interface, a network interface, or the like.

The controller 130A of the fabric network system 100A in the computing system 1000A illustrated in FIG. 3A allocates one or more storage devices corresponding to the QoS required from the host 1100 to the host 1100 by using the performance table 121 stored in the memory 120. For example, the controller 130A may allocate at least one group of storage devices corresponding to the QoS required from the host 1100 to the host 1100 based on the performance table per unit of a group of storage devices. That is, when the storage devices 200-1 to 200-N are classified into a plurality of groups based on an interface bandwidth, the controller 130A may allocate at least one group of storage devices to the host 1100. Alternatively or additionally, the performance table 121 may store performance information such as interface bandwidths for individual storage devices, and the controller 130A may allocate a storage device to the host 1100 based on the performance table per unit of an individual storage device. That is, when the storage devices 200-1 to 200-N have performance information such that an individual storage device satisfies the QoS requirement of the host 1100, the controller 130A may allocate one or more of the individual storage devices that satisfies the QoS requirement of the host 1100 to the host 1100.

FIG. 3B is another example of a structure of a computing system 1000B using the fabric network system 100B illustrated in FIG. 2, according to an example embodiment.

As illustrated in FIG. 3B, the computing system 1000B includes the host 1100 and a storage system 1200B. The storage system 1200B includes the fabric network system 100B and the plurality of storage devices SD1 to SDN 200-1 to 200-N (here, N is an integer that is equal to or greater than 2).

In the example embodiment of FIG. 3B, the fabric network system 100B is included in the storage system 1200B. As another example, the fabric network system 100B may be separated from the storage system 1200B and may have a separate structure. As another example, the fabric network system 100B may be configured to be included in the host 1100.

In the computing system 1000A of FIG. 3A, the fabric network system 100A illustrated in FIG. 1A is used, while in the computing system 1000B of FIG. 3B, the fabric network system 100B illustrated in FIG. 1B is used.

According to the structure of the computing system 1000B illustrated in FIG. 3B, the controller 130B of the fabric network system 100B allocates one or more storage devices corresponding to the QoS required from the host 1100 to the host 1100 by using the performance table 121 stored in the memory 120. For example, the controller 130B may allocate at least one group of storage devices corresponding to the QoS required from the host 1100 to the host 1100 based on the performance table 121 per unit of the group of storage devices. That is, when the storage devices 200-1 to 200-N are classified into a plurality of groups based on an interface bandwidth, one or more groups of storage devices may be allocated to the host 1100. Alternatively or additionally, the performance table 121 may store performance information such as interface bandwidths for individual storage devices, and the controller 130B may allocate a storage device to the host 1100 based on the performance table per unit of an individual storage device. That is, when the storage devices 200-1 to 200-N have performance information such that an individual storage device satisfies the QoS requirement of the host 1100, the controller 130B may allocate one or more of the individual storage devices that satisfies the QoS requirement of the host 1100 to the host 1100

Also, the controller 130B updates the performance table 121 stored in the memory 120 based on a result of monitoring by the monitor 140. Also, the controller 130B may adjust the interface bandwidth of one or more storage devices allocated to the host 1100 so that the interface performance monitored by the monitor 140 satisfies the performance of the QoS required from the host 1100.

FIG. 3C is another example of a structure of a computing system 1000C using the fabric network system 100A illustrated in FIG. 1, according to an example embodiment.

As illustrated in FIG. 3C, the computing system 1000C includes a plurality of hosts, for example HOST1 1100-1 to HOSTK 1100-K (here, K is an integer that is equal to or greater than 2) and the storage system 1200A. The storage system 1200A includes the fabric network system 100A and the plurality of storage devices SD1 to SDN 200-1 to 200-N.

The computing system 1000A illustrated in FIG. 3A has a structure in which a single host 1100 is linked to the fabric network system 100A, while the computing system 1000C illustrated in FIG. 3C has a structure in which the plurality of hosts 1100-1 to 1100-K are linked to the fabric network system 100A.

Each of the hosts 1100-1 to 1100-K includes hardware and software capable of communicating with the storage devices SD1 to SDN 200-1 to 200-N that are linked to each of the hosts 1100-1 to 1100-K via the fabric network system 100A. Also, each of the hosts 1100-1 to 1100-K may include hardware and software for performing various computational processing operations.

For example, each of the hosts 1100-1 to 1100-K may provide external interface bandwidth configuration information to the fabric network device 110 in a process of setting communication with the fabric network system 100. Also, each of the hosts 1100-1 to 1100-K may provide the QoS information required by the host 1100 to the fabric network device 100.

An interface configured to connect the hosts 1100-1 to 1100-K to the storage devices SD1 to SDN 200-1 to 200-N may include various interfaces, such as a PCIe interface, a SAS interface, a SATA interface, a network interface, etc.

According to the structure of the computing system 1000C illustrated in FIG. 3C, the controller 130A of the fabric network system 100A allocates one or more storage devices corresponding to the QoS required from each of the hosts 1100-1 to 1100-K to each of the hosts 1100-1 to 1100-K by using the performance table 121 stored in the memory 120. For example, the controller 130A may allocate at least one group of storage devices corresponding to the QoS required from each of the hosts 1100-1 to 1100-K to the respective hosts 1100-1 to 1100-K based on the performance table per unit of the group of storage devices. Thus, the controller 130A may allocate at least one group of storage devices corresponding to the QoS required from the host 1100-1 to the host 1100-1, and may allocated at least one group of storage devices corresponding to the QoS required from the host 1100-2 to the host 1100-2, etc. That is, when the storage devices 200-1 to 200-N are classified into a plurality of groups based on an interface bandwidth, the controller 130A may allocate one or more groups of storage devices satisfying the QoS required from the hosts 1100-1 to 1100-K to the respective hosts 1100-1 to 1100-K. Alternatively or additionally, the performance table 121 may store performance information such as interface bandwidths for individual storage devices, and the controller 130A may allocate one or more storage devices to each of the hosts 1100-1 to 1100-K based on the performance table per unit of an individual storage device. That is, when the storage devices 200-1 to 200-N have performance information such that individual storage devices satisfy the QoS requirement of one or more of the hosts 1100-1 to 1100-K, the controller 130A may allocate one or more of the individual storage devices that satisfies the QoS requirement of the host 1100 to 1100-K to the respective host 1100-1 to 1100-K.

FIG. 3D is another example of the structure of the computing system 1000D using the fabric network system 100B, according to an embodiment.

As illustrated in FIG. 3D, the computing system 1000D includes the plurality of hosts 1100-1 to 1100-K (here, K is an integer that is equal to or greater than 2) and the storage system 1200B. The storage system 1200B includes the fabric network system 100B and the plurality of storage devices SD1 to SDN 200-1 to 200-N.

According to the structure of the computing system 1000D illustrated in FIG. 3D, the controller 130B of the fabric network system 100B allocates one or more storage devices corresponding to the QoS required from each of the hosts 1100-1 to 1100-K to the respective hosts 1100-1 to 1100-K by using the performance table 121 stored in the memory 120. Thus, the controller 130B may allocate at least one group of storage devices corresponding to the QoS required from the host 1100-1 to the host 1100-1, and may allocated at least one group of storage devices corresponding to the QoS required from the host 1100-2 to the host 1100-2, etc. For example, the controller 130B may allocate at least one group of storage devices corresponding to the QoS required from each of the hosts 1100-1 to 1100-K to the respective hosts 1100-1 to 1100-K based on the performance table per unit of the group of storage devices. That is, when the storage devices 200-1 to 200-N are classified into a plurality of groups based on an interface bandwidth, the controller 130B may allocate one or more groups of storage devices satisfying the QoS required from each of the hosts 1100-1 to 1100-K to the respective hosts 1100-1 to 1100-K. Alternatively or additionally, the performance table 121 may store performance information such as interface bandwidths for individual storage devices, and the controller 130B may allocate one or more storage devices to each of the hosts 1100-1 to 1100-K based on the performance table per unit of an individual storage device. That is, when the storage devices 200-1 to 200-N have performance information such that individual storage devices satisfy the QoS requirement of one or more of the hosts 1100-1 to 1100-K, the controller 130A may allocate one or more of the individual storage devices that satisfies the QoS requirement of the host 1100 to 1100-K to the respective host 1100-1 to 1100-K.

In addition, the controller 130B updates the performance table 121 stored in the memory based on a result of the monitoring by the monitor 140. Also, the controller 130B may adjust the interface bandwidth of the one or more storage interfaces allocated to each of the hosts 1100-1 to 1100-K so that the interface performance monitored by the monitor 40 satisfies the performance of the QoS required from each of the hosts 1100-1 to 1100-K.

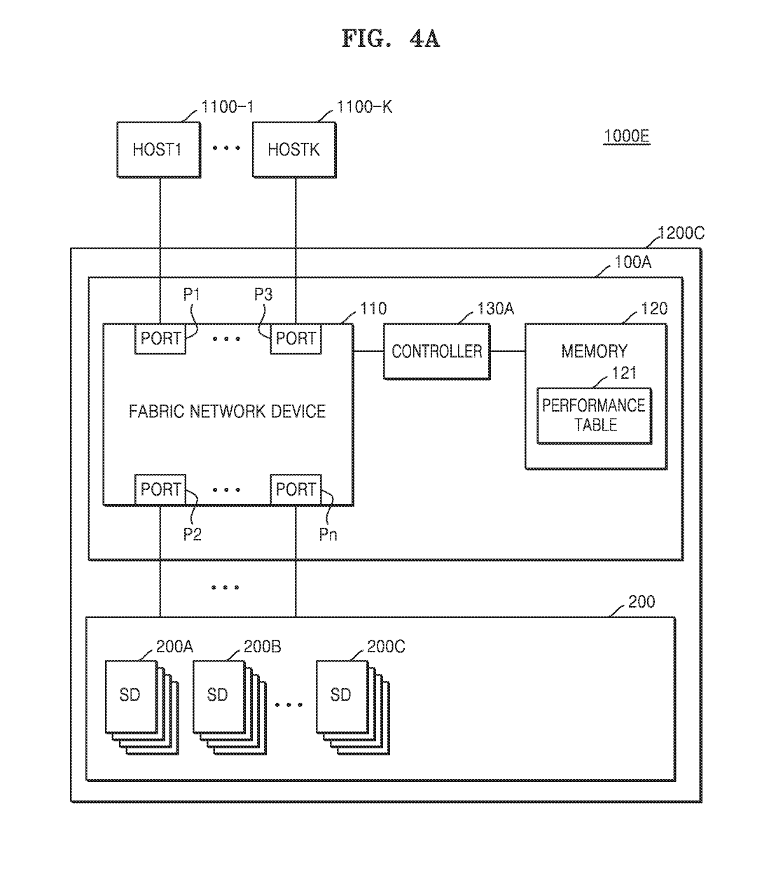

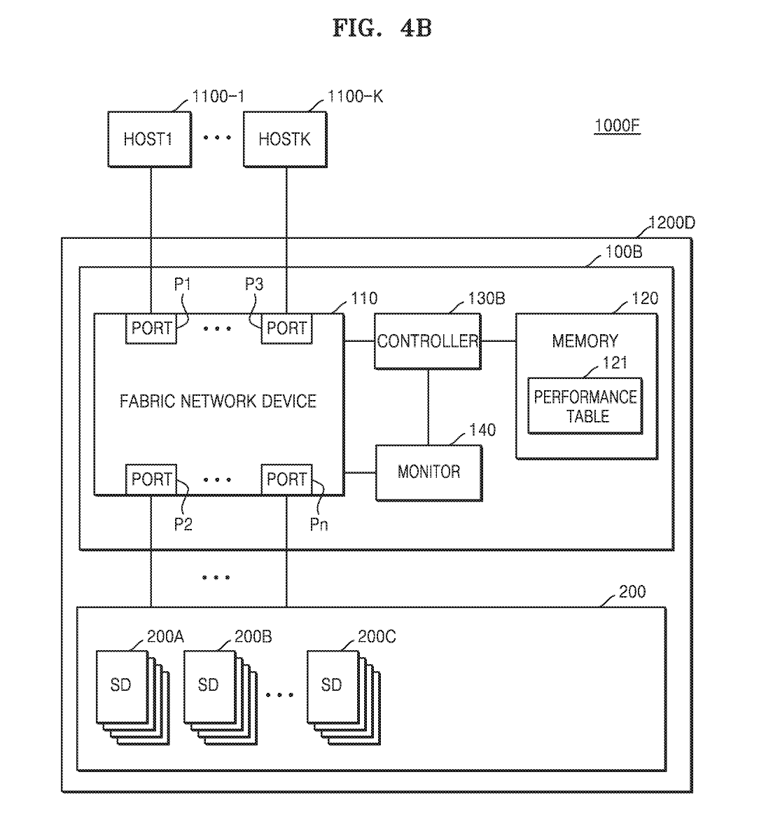

FIG. 4A is a view for describing an example of a method in which QoS is managed per unit of an interface bandwidth group of storage devices in a computing system 1000E using a fabric network system 100A, according to an example embodiment.

As illustrated in FIG. 4A, the computing system 1000E includes the plurality of hosts 1100-1 to 1100-K (here, K is an integer that is equal to or greater than 2) and a storage system 1200C. The storage system 1200C includes the fabric network system 100A and a storage device block 200.

The controller 130A of the fabric network system 100A classifies and groups a plurality of storage devices included in the storage device block 200 based on bandwidths of the storage devices. For example, storage devices having a first bandwidth may be classified as a first group of storage devices 200A, storage devices having a second bandwidth may be classified as a second group of storage devices 200B, and storage devices having a third bandwidth may be classified as a third group of storage devices 200C.

The performance table 121 stored in the memory 120 may be generated per unit of the group of storage devices classified based on the bandwidth or a performance specification. That is, the performance table 121 may be generated with respect to each of the groups 200A to 200C of the storage device block 200 and stored in the memory 120.

The controller 130A of the computing system 1000E illustrated in FIG. 4A allocates at least one group of storage devices corresponding to the QoS required from each of the hosts 1100-1 to 1100-K to the respective hosts 1100-1 to 1100-K based on the performance table 121 per unit of the group of storage devices. That is, the controller 130A allocates at least one group of storage devices corresponding to the QoS required from host 1100-1 to host 1100-1, and allocates at least one group of storage devices corresponding to the QoS required from host 1100-2 to host 1100-2, etc.

FIG. 4B is a view for describing an example of a method in which QoS is managed per unit of an interface bandwidth group of storage devices in a computing system 1000F using the fabric network system 100B, according to an example embodiment.

As illustrated in FIG. 4B, the computing system 1000F includes the plurality of hosts 1100-1 to 1100-K (here, K is an integer that is equal to or greater than 2) and a storage system 1200D. The storage system 1200D includes the fabric network system 100B and the storage device block 200.

The controller 130B of the fabric network system 100B classifies and groups a plurality of storage devices included in the storage device block 200 based on bandwidths of the storage devices. For example, the storage devices having the first bandwidth may be classified as the first group of storage devices 200A, the storage devices having the second bandwidth may be classified as the second group of storage devices 200B, and the storage devices having the third bandwidth may be classified as the third group of storage devices 200C.

The performance table 121 stored in the memory 120 may be generated per unit of the group of storage devices classified based on the bandwidth. That is, the performance table may be generated with respect to each of the groups 200A to 200C of the storage device block 200 and stored in the memory 120.

The monitor 140 monitors an external interface state with respect to the hosts 1100-1 to 1100-K linked to one or more of the plurality of ports P1 to Pn of the fabric network device 110, and an internal interface state with respect to the groups of storage devices 200A to 200C linked to one or more of the ports P1 to Pn of the fabric network device 10. For example, the monitor 140 may monitor an interface performance according to the group of storage devices allocated to the host in the fabric network device 110.

Also, the controller 130B updates the performance table 121 with respect to each of the groups of storage devices 200A to 200C, which is stored in the memory 120, based on a result of monitoring by the monitor 140. Also, the controller 130B may adjust the interface bandwidth of the one or more storage devices allocated to each of the hosts 1100-1 to 1100-K so that the interface performance monitored by the monitor 140 satisfies the QoS performance required from each of the hosts 1100-1 to 1100-K.

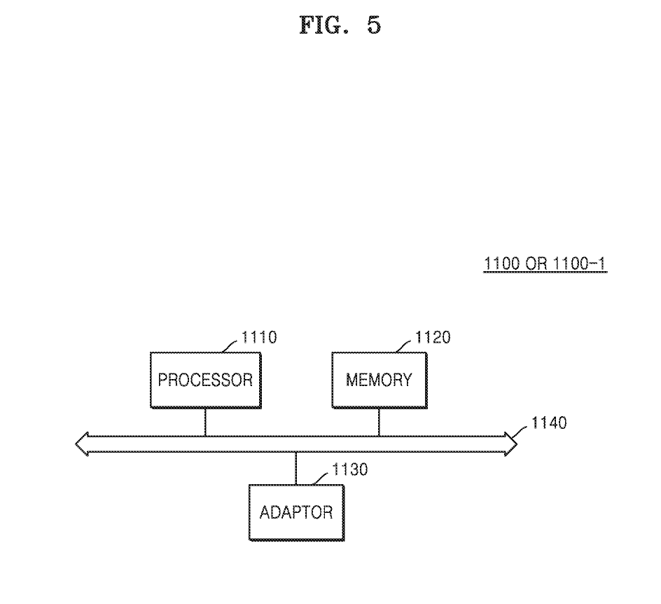

FIG. 5 is a view of a structure of the host 1100 or 1100-1 illustrated in FIGS. 3A to 3D and FIGS. 4A to 4B, according to an example embodiment.

As illustrated in FIG. 5, the host 1100 or 1100-1 includes a processor 1110, a memory 1120, an adaptor 1130, and a bus 1140.

The processor 1100, the memory 1120, and the adaptor 1130 may be linked to the bus 1140 and may exchange data or signals via the bus 1140.

The processor 1100 may include circuits, interfaces, or program codes for processing data or controlling operations of components. For example, the processor 1110 may include a central processing unit (CPU), advanced reduced instruction set computer machines (ARM), or an application specific integrated circuit (ASIC), or a plurality of CPUs, ARMs, ASICs, etc.

The memory 1120 may include SRAM or DRAM for storing data, instructions, or program codes used for an operation of the host 1100 or 1100-1. Also, the memory 1120 may include a non-volatile memory. The memory 1120 may store program codes configured to operate to execute one or more operating systems and virtual machines (VMs). Also, the memory 1120 may store program codes for executing a hypervisor for managing the VMs.

The processor 1100 using the memory 1120 may operate to execute the one or more operating systems and the VMs. Also, the processor 1110 may execute the hypervisor for managing the VMs or may be controlled by the hypervisor.

The processor 1110 may include a software switch implemented by the hypervisor in order to provide network linkage among the VMs or connectivity between the VMs and the storage devices 200-1 to 200-N via the network system 100.

The processor 1110 may provide interface bandwidth configuration information to the fabric network device 110 in a process of setting communication with the fabric network system 100.

The adaptor 1130 links the fabric network system 100 to the host 1100 or 1100-1. For example, the adaptor 1130 may include a host bus adaptor (HBA) or a network adaptor. For example, the HBA may include a small computer system interface (SCSI) adaptor, a Fibre channel adaptor, a serial ATA adaptor, etc. The network adaptor may be coupled to the storage device block 200 via a link unit. For example, the link unit may include copper wirings, fiber optic cables, one or more wireless channels, or a combination thereof. Also, the network adaptor may include circuits, interfaces, or codes which may operate to transmit and receive data according to one or more networking standards.

For example, the adaptor 1130 may include, as an interface to connect to the storage devices SD1 to SDN 200-1 to 200-N via the fabric network system 100, a PCIe interface, a SAS interface, a SATA interface, a network interface, etc.

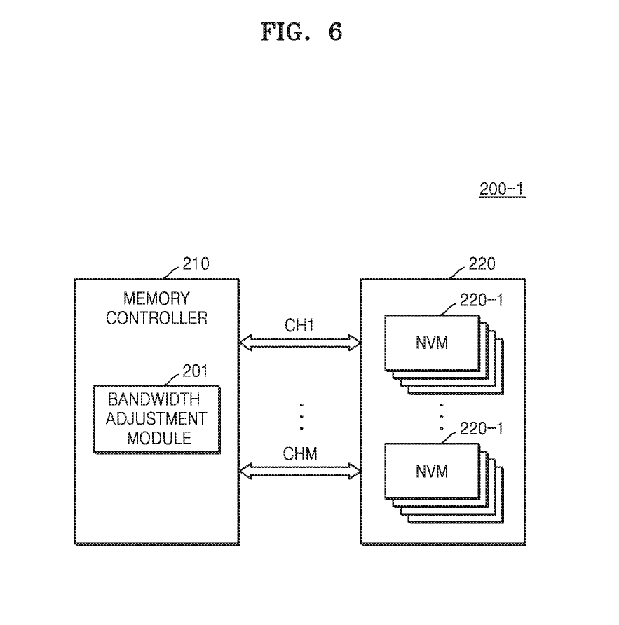

FIG. 6 is a view of a structure of the storage device 200-1 illustrated in FIGS. 3A to 3D and FIGS. 4A to 4B, according to an example embodiment.

As illustrated in FIG. 6, the storage device 200-1 includes a memory controller 210 and a memory device 220.

The memory device 220 may include one or more non-volatile memories (NVM) 220-1. For example, the NVM 220-1 applied to the memory device 220 may include flash memory, phase change RAM (PRAM), ferroelectric RAM (FRAM), magnetic RAM (MRAM), etc. As another example, the memory device 220 may include at least one non-volatile memory and at least one volatile memory. Alternatively, the memory device 220 may include at least two types of NVMs.

The memory controller 210 may control the memory device 220 based on commands received from a host. The memory controller 210 controls programming (or writing), reading, and erasing operations with respect to the memory device 220 linked to the memory controller 210 via a plurality of channels CH1 to CHM in response to commands received from the host.

Channels to perform I/O processing on signals used for performing operations are formed between the memory controller 210 and the memory device 220. The signals necessary for performing the operations may include, for example, commands, addresses, and data.

The memory controller 210 includes a bandwidth adjustment module 201. The bandwidth adjustment module 201 includes hardware and software for performing bandwidth adjustment for adjusting an interface latency with the fabric network system 100A or 100B. The memory controller 210 adjusts an interface bandwidth of the storage device 200-1 based on an internal interface adjustment request by using the bandwidth adjustment module 201, when the internal interface adjustment request is received from the fabric network system 100A or 100B. When the interface bandwidth of the storage device increases, the interface latency decreases and power consumption increases. On the contrary, when the interface bandwidth of the storage device decreases, the interface latency increases and power consumption decreases.

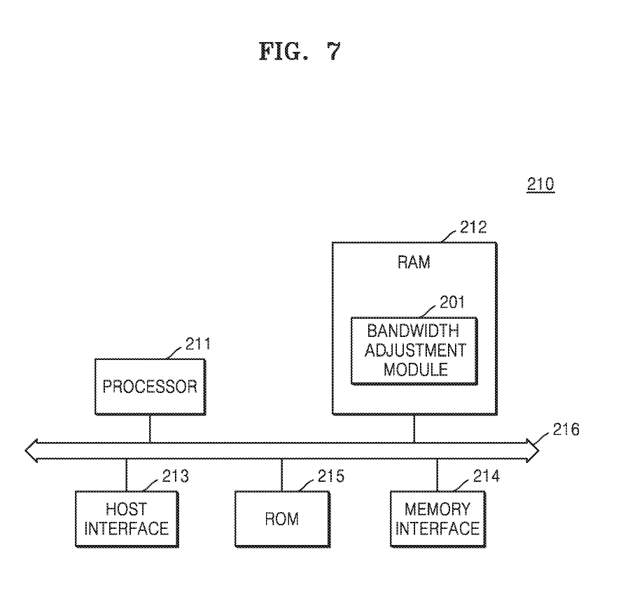

FIG. 7 is a view of a structure of the memory controller 210 illustrated in FIG. 6, according to an example embodiment.

As illustrated in FIG. 7, the memory controller 210 includes a processor 211, a RAM 212, a host interface 213, a memory interface 214, a ROM 215, and a bus 216.

The components of the memory controller 210 transmit and receive data and various signals to and from one another via the bus 216.

The processor 211 may generally control operations of the storage device 200-1 by using program codes and data stored in the RAM 212. When the storage device 200-1 is initialized, the processor 211 may read program codes and data used to control the operations performed by the storage device 200-1, stored in the memory device 220, and load the program codes and data to the RAM 212. Software for the bandwidth adjustment module 201 may be loaded to the RAM 212.

The host interface 213 includes a protocol for data exchange with the host linked to the memory controller 210 and performs an interface between the memory controller 210 and the host. The host interface 213 may include, for example, an ATA interface, a SATA interface, a parallel advanced technology attachment (PATA) interface, a universal serial bus (USB) interface, a SAS interface, a SCSI interface, an embedded multi-media card (eMMC) interface, a universal flash storage (UFS) interface, a PCI interface, a PCIe interface, a network interface, etc. However, they are only exemplary, and the host interface 213 is not limited thereto. The host interface 213 may receive commands and data from the host or transmit data to the host according to control of the processor 211.

The memory interface 214 is electrically connected to the memory device 220. The memory interface 214 may transmit commands, addresses, and data to the memory device 220 or receive data from the memory device 220 according to control of the processor 211. The memory interface 214 may be configured to support a NAND flash memory or a NOR flash memory. The memory interface 214 may be configured to perform software or hardware interleaved operations via a plurality of channels.

The ROM 215 may store code information used for initial booting of a device to which the storage device is linked.

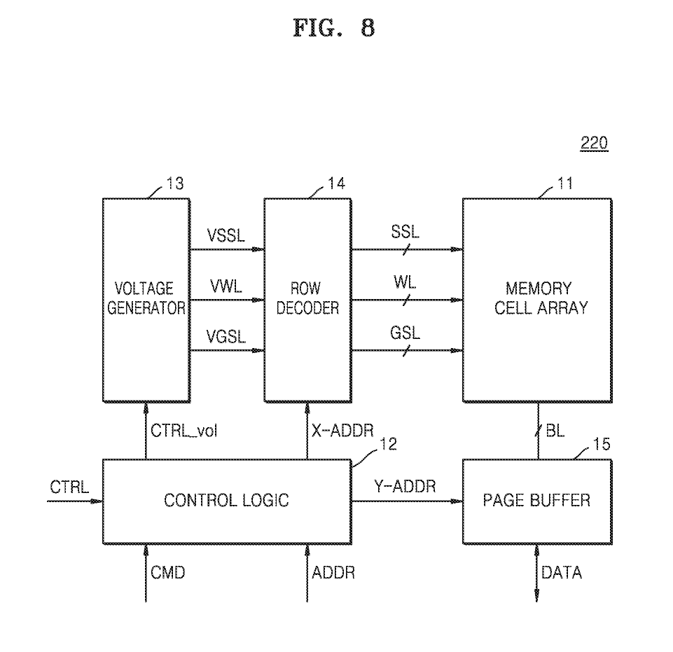

FIG. 8 is a view of an example of a detailed structure of the memory device 220 illustrated in FIG. 6.

Referring to FIG. 8, the memory device 220 may include a memory cell array 11, a control logic 12, a voltage generator 13, a row decoder 14, and a page buffer 15. Hereinafter, the components included in the memory device 220 will be described.

The memory cell array 11 may be connected to one or more string selection lines SSLs, a plurality of word lines WLs, one or more ground selection lines GSLs, and a plurality of bit lines BLs. The memory cell array 11 may include a plurality of memory cells MCs arranged in areas in which the plurality of word lines WLs and the plurality of bit lines BLs cross each other.

When an erase voltage is applied to the memory cell array 11, the plurality of memory cells MCs are erased, and when a program voltage is applied to the memory cell array 11, the plurality of memory cells MCs are programmed. Here, each of the memory cells MCs may have any one of an erasing state, first to n^{th} programmed states P1 to Pn, which are divided according to a threshold voltage.

Here, n is a natural number that is equal to or greater than 2. For example, when the memory cell MC is a two bit level cell, n may be 3. As another example, when the memory cell MC is a three bit level cell, n may be 7. As another example, when the memory cell MC is a four bit level cell, n may be 15. As shown above, the plurality of memory cells MCs may include multi-level cells. However, the present inventive concept is not limited thereto. The plurality of memory cells MCs may include single level cells.

The control logic 12 may output various control signals for writing data to the memory cell array 11 or reading data from the memory cell array 11, based on a command CMD, an address ADDR, and a control signal CTRL received from the memory controller 210A. By doing this, the control logic 12 may generally control various operations in the memory device 220.

The various control signals output from the control logic 12 may be provided to the voltage generator 13, the row decoder 14, and the page buffer 15. In detail, the control logic 12 may provide a voltage control signal CTRL_vol to the voltage generator 13, provide a row address X_ADDR to the row decoder 14, and provide a column address Y_ADDR to the page buffer 15.

The voltage generator 13 may generate voltage of various types for performing program, read, and erase operations on the memory cell array 11, based on the voltage control signal CTRL_vol. In detail, the voltage generator 13 may generate a first driving voltage VWL for driving the plurality of word lines WLs, a second driving voltage VSSL for driving the plurality of string selection lines SSLs, and a third driving voltage VGSL for driving the plurality of ground selection lines GSLs.

Here, the first driving voltage VWL may be a program voltage (or a write voltage), a read voltage, an erase voltage, a pass voltage, or a program verification voltage. Also, the second driving voltage VSSL may be a string selection voltage, that is, an on voltage or an off voltage. Further, the third driving voltage VGSL may be a ground selection voltage, that is, an on voltage or an off voltage.

The row decoder 14 may be connected to the memory cell array 11 via the plurality of word lines WLs, and may activate some of the plurality of word lines WLs in response to the row address X_ADDR received from the control logic 12. In detail, during the read operation, the row decoder 14 may apply a read voltage to a selected word line and apply a pass voltage to a non-selected word line.

Meanwhile, during the program operation, the row decoder 14 may apply a program voltage to a selected word line and apply a pass voltage to a non-selected word line. In the present embodiment, the row decoder 14 may apply the program voltage to the selected word line and an additional selected word line from at least one of program loops.

The page buffer 15 may be connected to the memory cell array 11 via the plurality of bit lines BL. In detail, during the read operation, the page buffer 15 may operate as a sense amplifier and output data DATA stored in the memory cell array 11. Meanwhile, during the program operation, the page buffer 15 may operate as a write driver and input data DATA that is to be stored in the memory cell array 11.

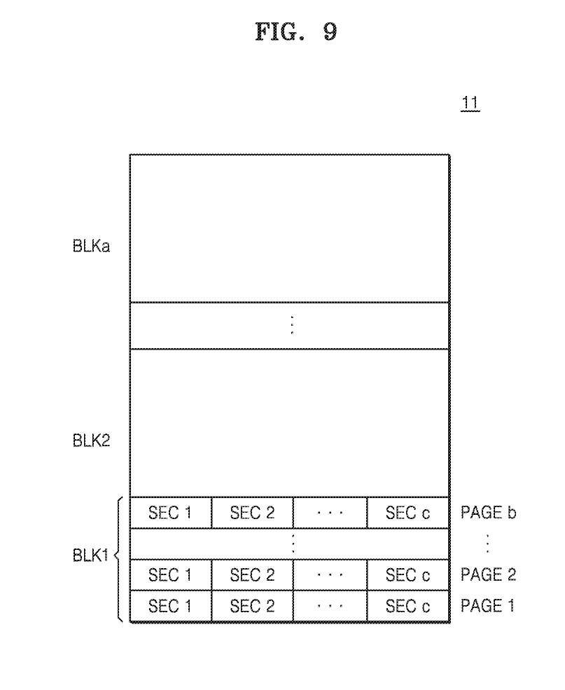

FIG. 9 is an example of the memory cell array 11 illustrated in FIG. 8.

Referring to FIG. 9, the memory cell array 11 may be a flash memory cell array. Here, the memory cell array 11 may include a (a is an integer that is equal to or greater than 2) memory blocks BLK1 to BLKa, each of the memory blocks BLK1 to BLKa may include b (b is an integer that is equal to or greater than 2) pages PAGE 1 to PAGEb, and each of the pages PAGE1 to PAGEb may include c (c is an integer that is equal to or greater than 2) sectors SEC 1 to SEC c. In FIG. 9, for convenience of illustration, the pages PAGE1 to PAGEb and the sectors SEC 1 to SEC c are illustrated only with respect to the memory block BLK1. However, other memory blocks BLK2 to BLKa may also have the same structure as the memory block BLK1.

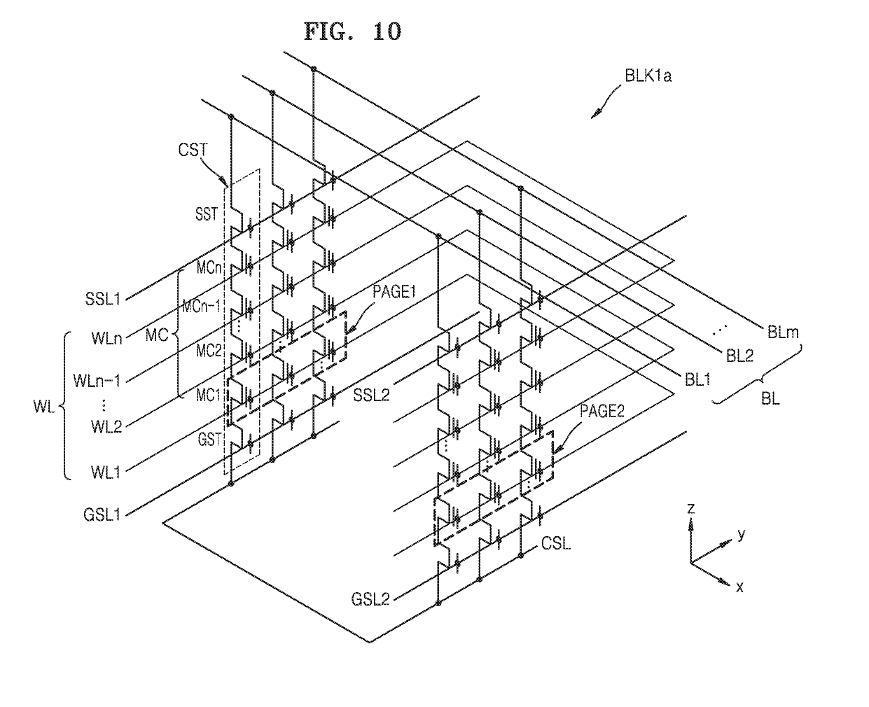

FIG. 10 is a circuit diagram of an example of a first memory block BLK1 included in the memory cell array 11 illustrated in FIG. 9.

Referring to FIG. 10, the first memory block BLK1 may be a vertical structure NAND flash memory. Here, each of the blocks BLK1 to BLKa illustrated in FIG. 9 may have the structure shown in FIG. 10. In FIG. 10, a first direction will be referred to as an x direction, a second direction will be referred to as a y direction, and a third direction will be referred to as a z direction. However, the present inventive concept is not limited thereto, and the first to third directions may be changed.

The first memory block BLK1 may include a plurality of cell strings CSTs, a plurality of word lines WLs, a plurality of bit lines BL, a plurality of ground selection lines GSL1 and GSL2, a plurality of string selection lines SSL1 and SSL2, and a common source line CSL. Here, the numbers of cell strings CST, word lines WL, bit lines BL, ground selection lines GSL1 and GSL2, and string selection lines SSL1 and SSL2 may vary according to embodiments.

The cell string CST may include a string selection transistor SST, a plurality of memory cells MC, and a ground selection transistor GST, connected in series between the corresponding bit line BL and source line CSL. However, the present inventive concept is not limited thereto. In another example embodiment, the cell string CST may further include at least one dummy cell. In another example embodiment, the cell string CST may include at least two string selection transistors or at least two ground selection transistors.

Also, the cell string CST may extend in the third direction (the z direction). In detail, the cell string CST may extend on a substrate in the vertical direction (the z direction). Thus, the memory block BLK1 including the cell string CST may be referred to as the vertical direction NAND flash memory. As shown above, since the cell string CST extends on the substrate in the vertical direction (the z direction), a degree of integration of the memory cell array 11 may be improved.

The plurality of word lines WLs may extend in the first direction (the x direction) and the second direction (the y direction), and each word line WL may be connected to the corresponding memory cells MCs. Accordingly, the plurality of memory cells MCs arranged adjacent to one another on the same layer in the first direction (the x direction) and the second direction (the y direction) may be connected to the same word line WL. In detail, each word line WL may be connected to a gate of the memory cell MC and may control the memory cell MC. Here, the plurality of memory cells MCs may store data, and may be programmed, read, or erased according to control of the connected word line WL.

The plurality of bit lines BLs may extend in the first direction (the x direction) and may be connected to the string selection transistor SST. Accordingly, the plurality of string selection transistors SSTs arranged adjacent to one another in the first direction (the x direction) may be connected to the same bit line BL. In detail, each bit line BL may be connected to a drain of the string selection transistor SST.

The plurality of string selection lines SSL1 and SSL2 may extend in the second direction (the y direction) and may be connected to the string selection transistor SST. Accordingly, the plurality of string selection transistors SSTs arranged adjacent to one another in the second direction (the y direction) may be connected to the same string selection line SSL1 to SSL2. In detail, each string selection line SSL1 or SSL2 may be connected to a gate of the string selection transistor SST and may control the string selection transistor SST.

The plurality of ground selection lines GSL1 and GSL2 may extend in the second direction (the y direction) and may be connected to the ground selection transistor GST. Accordingly, the plurality of ground selection transistors GSTs arranged adjacent to one another in the second direction (the y direction) may be connected to the same ground selection line GSL1 to GSL2. In detail, each ground selection line GSL1 or GSL2 may be connected to a gate of the ground selection transistor GST and may control the ground selection transistor GST.

Also, the ground selection transistors GST included in each cell string CST may be commonly connected to the common source line CSL. In detail, the common source line CSL may be connected to a source of the ground selection transistor GST.

Here, the plurality of memory cells MCs commonly connected to the same word line WL and the same string selection line SSL1 or SSL2 and arranged adjacent to one another in the second direction (the y direction) may be referred to as a page PAGE. For example, the plurality of memory cells MC commonly connected to a first word line WL1, commonly connected to a first string selection line SSL1, and arranged adjacent to one another in the second direction (the y direction) may be referred to as a first page PAGE1. Also, the plurality of memory cells MC commonly connected to the first word line WL1, commonly connected to a second string selection line SSL2, and arranged adjacent to one another in the second direction (the y direction) may be referred to as a second page PAGE2.

In order to perform a program operation on the memory cells MCs, 0V may be applied to the bit line BL, an on voltage may be applied to the string selection line SSL, and an off voltage may be applied to the ground selection line GSL. The on voltage may be equal to or greater than a threshold voltage of the string selection transistor SST so as to turn on the string selection transistor SST, and the off voltage may be less than the threshold voltage of the ground selection transistors GSTs so as to turn off the ground selection transistors GSTs. Also, a program voltage may be applied to a selected memory cell from among the memory cells MCs, and a pass voltage may be applied to the reset memory cells. When the program voltage is applied to the selected memory cell, a charge may be loaded onto the memory cells MCs via F-N tunneling. The pass voltage may be greater than the threshold voltage of the memory cells MC.

In order to perform an erase operation on the memory cells MCs, an erase voltage may be applied to a body of the memory cells MCs, and 0V may be applied to the word lines WLs. Accordingly, data of the memory cells MCs may be erased at once.

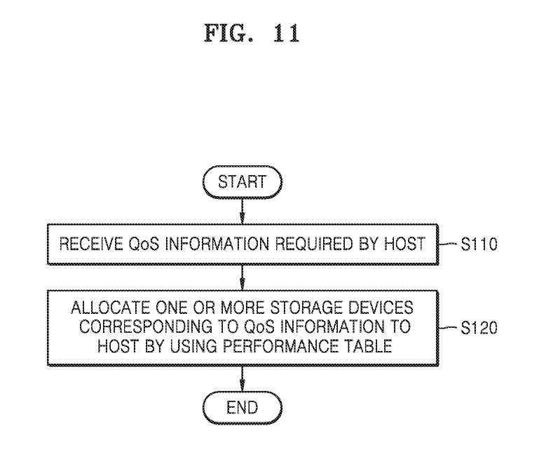

FIG. 11 is a flowchart of an example of a QoS method in a fabric network, according to an example embodiment.

An example of the QoS management method in the fabric network of various types of computing systems 1000A, 1000C, or 1000E in which the fabric network system 100A illustrated in FIG. 1A is applied will be described with reference to the flowchart of FIG. 11.

The fabric network system 100A receives QoS information required by a host in operation S110. When a plurality of hosts are linked to the fabric network, the fabric network system 100A receives the QoS information required by each of the hosts.

The fabric network system 100A allocates one or more storage devices corresponding to the QoS information required by the host to the host by using a performance table in operation S120. For example, the controller 130A of the fabric network system 100A may allocate one or more storage devices corresponding to the QoS information required by the host to the host from the performance table 121 stored in the memory 120. For example, the controller 130A may allocate at least one group of storage devices corresponding to the QoS required by each of the hosts to the respective hosts, based on the performance table 121 per unit of a group of storage devices. Alternatively or additionally, the controller 130A may allocate one or more storage devices corresponding to the QoS required by each of the hosts to the respective hosts based on the performance table 121 per unit of an individual storage device.

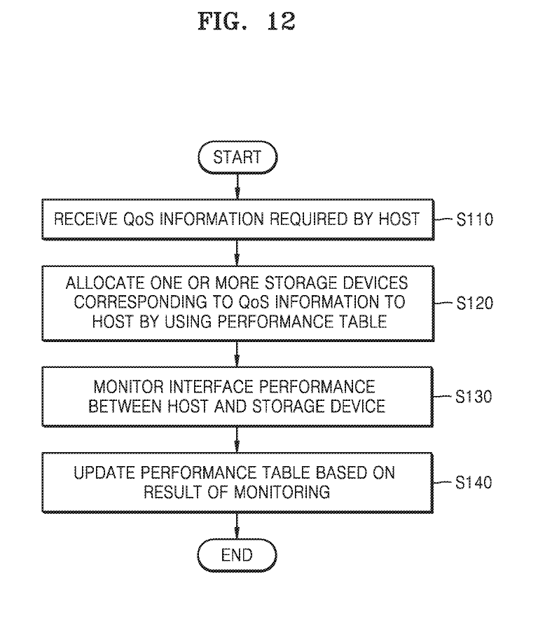

FIG. 12 is another example of a flowchart of a QoS method in the fabric network, according to an example embodiment.

An example of the QoS management method in the fabric network of various types of computing systems 1000B, 1000D, or 1000F in which the fabric network system 100B illustrated in FIG. 1B is applied will be described with reference to the flowchart of FIG. 12.

The fabric network system 100B performs operations S110 and S120 described above with respect to FIG. 11. The operations S110 and S120 are the same as described above and a repeated description will thus be omitted. The fabric network system 110B may additionally perform operation S130 and operation S140, after performing operation S110 and operation S120 illustrated in the flowchart of FIG. 11.

The fabric network system 100B monitors interface performance between the host and the storage device in operation S130, after allocating one or more storage devices to the host. For example, the monitor 140 of the fabric network system 100B monitors an external interface state with the host linked to one or more of the ports P1 to Pn of the fabric network device 110 and an internal interface state with the storage device linked to one or more of the ports P1 to Pn of the fabric network device 110. For example, the monitor 140 may monitor the interface performance according to the group of storage devices allocated to the host via the fabric network device 110B.

Next, the fabric network system 100B updates the performance table based on a result of monitoring in operation S140. For example, the controller 130B of the fabric network system 100B may update the performance table 121 per unit of the group of storage devices, stored in the memory 120, based on the result of monitoring by the monitor 140. Alternatively or additionally, the controller 130B of the fabric network system 100B may update the performance table 121 per unit of individual storage devices, stored in the memory 120, based on the result of the monitoring by the monitor 140.

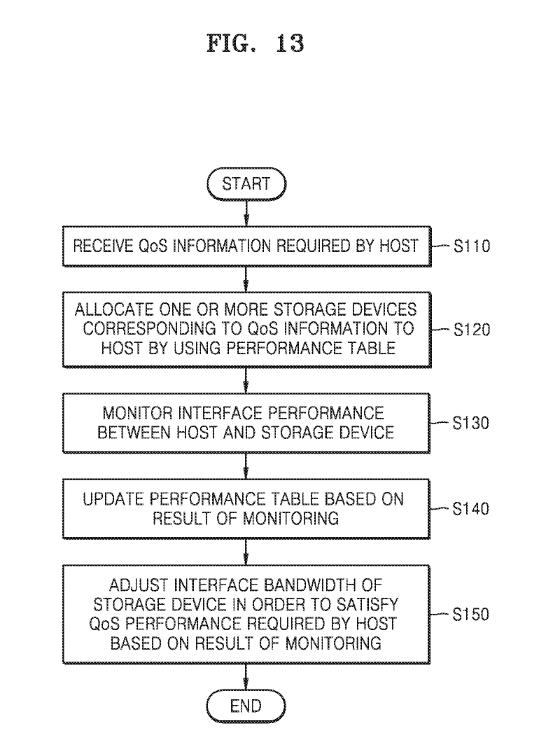

FIG. 13 is another example of a flowchart of a QoS management method in the fabric network, according to an example embodiment.

An example of the QoS management method in the fabric network of various types of computing systems 1000B, 1000D, or 1000F in which the fabric network system 100B illustrated in FIG. 1B is applied will be described with reference to the flowchart of FIG. 13.

The fabric network system 100B performs operations S110 to S140 described above with respect to FIG. 12. The operations S110 to S140 are the same as described above and a repeated description will thus be omitted. The fabric network system 110B may additionally perform operation S150, after performing operations S110-140 illustrated in the flowchart of FIG. 12.

In operation S150, after updating the performance table, the fabric network system 100B adjusts an interface bandwidth of the storage device allocated to the host so as to satisfy the QoS performance required by the host based on the result of monitoring. For example, the controller 130B of the fabric network system 100B may adjust the interface bandwidth of one or more storage devices allocated to each of the hosts so that the interface performance monitored by the monitor 140 satisfies the QoS performance required by the respective hosts. For example, when the performance based on information of the monitored interface performance does not satisfy the QoS performance required by the host, the controller 130B of the fabric network system 100B may make an adjustment to increase the interface bandwidth of one or more storage devices allocated to the host in order to satisfy the QoS performance. For example, when a group of storage devices is allocated to the host based on the interface bandwidth, the controller 130B may adjust the interface bandwidth of the group of storage devices. Alternatively or additionally, when an individual storage device is allocated to the host based on the interface bandwidth, the controller 130B may adjust the interface bandwidth of the individual storage device.

While the inventive concept has been particularly shown and described with reference to example embodiments thereof, it will be understood that various changes in form and details may be made therein without departing from the spirit and scope of the following claims.

What is claimed is:

1. A quality of service (QoS) management method in a fabric network, the method comprising:
receiving QoS information from a host via the fabric network; and
allocating one or more storage devices corresponding to the QoS information received from the host to the host by using a performance table which is initially set with respect to storage devices.

2. The QoS management method of claim 1, wherein the performance table comprises bandwidth information for each of a plurality of groups of storage devices, and is initially generated per unit of a group of storage devices, each group classified based on a bandwidth of the storage devices in the group.

3. The QoS management method of claim 1, wherein the allocating comprises allocating at least one group of storage devices corresponding to the QoS information received from the host, to the host, from the performance table, and
wherein the performance table comprises interface bandwidth information for each of a plurality of groups of storage devices, and the performance table is initially generated per unit of a group of storage devices, and each group is classified based on an interface bandwidth of the storage devices in the group.

4. The QoS management method of claim 1, wherein the allocating comprises allocating at least one group of storage devices corresponding to the QoS information received from the host, to the host, from the performance table, and
wherein the performance table comprises performance specification information for each of a plurality of groups of storage devices, and the performance table is initially generated per unit of a group of storage devices, each group classified based on a performance specification of the storage devices in the group.

5. The QoS management method of claim 1, wherein the performance table is configured to represent interface performance based on an interface bandwidth of an interface, the number of storage devices connected to the interface, and a queue depth of the interface.

6. The QoS management of method of claim 1, wherein the performance table comprises at least one of an input/output (I/O) performance table and a latency performance table, based on an interface bandwidth of an interface, the number of storage devices connected to the interface, and a queue depth of the interface.

7. The QoS management method of claim 1, further comprising:
monitoring a performance of an interface between the host and the storage devices in the fabric network; and
updating the performance table based on the monitored performance of the interface.

8. The QoS management method of claim 7, further comprising adjusting an interface bandwidth of an interface of the storage devices based on the monitored performance of the interface in order to satisfy a QoS required by the host indicated by the QoS information received from the host.

9. The QoS management method of claim 1, wherein the QoS information comprises I/O bandwidth information and latency information.

10. The QoS management method of claim 1, wherein an interface configured to connect the host and the storage devices via the fabric network comprises a peripheral component interconnect express (PCIe) interface, a serial attached small computer system (SAS) interface, a serial advanced technology attachment (SATA) interface, or a network interface.

11. A fabric network system comprising:
a fabric network device comprising a plurality of ports and configured to support communication between a host linked to one or more of the ports and storage devices linked to one or more of the ports;
a memory configured to store a performance table configured to represent an interface performance of an interface based on an interface bandwidth of the interface, the number of storage devices connected to the interface, and a queue depth of the interface; and
a controller configured to receive quality of service (QoS) information from the host and to allocate one or more storage devices corresponding to the received QoS information to the host by using the performance table.

12. The fabric network system of claim 11, further comprising a monitor configured to monitor the interface performance depending on the one or more storage devices allocated to the host,
wherein the controller is configured to update the performance table based on the monitored interface performance.

13. The fabric network system of claim 12, wherein the controller is further configured to adjust an interface bandwidth of the one or more storage devices allocated to the host so that the monitored interface performance satisfies a QoS performance of the host indicated by the received QoS information from the host.

14. The fabric network system of claim 11, wherein the performance table comprises at least one of an input/output (I/O) performance table and a latency performance table based on the interface bandwidth, the number of storage devices, and the queue depth.

15. The fabric network system of claim 11, wherein the performance table comprises bandwidth or performance specification information for each of a plurality of groups of storage devices, and is generated per unit of a group of storage devices, each group classified based on a bandwidth or a performance specification of the storage devices, and
the controller is configured to allocate at least one group of storage devices corresponding to a QoS required by the host indicated by the QoS information received from the host, based on the performance table per unit of the group of storage devices.

16. A fabric network system comprising:
a fabric network device comprising a plurality of ports;
a memory configured to store a performance table that includes interface performance information set in advance for each of a plurality of storage devices; and
a controller configured to receive quality of service (QoS) information from a host coupled to a port, and to allocate one or more storage devices coupled to one or more of the ports using the received QoS information of the host and the interface performance information.

17. The fabric network system of claim 16, wherein the interface performance information is set per unit of a group of storage devices, each group classified based on performance characteristics of the storage devices in the group.

18. The fabric network system of claim 16, further comprising a monitor configured to monitor the interface performance of an interface between the host and the one or more storage devices allocated to the host,
wherein the controller is configured to update the interface performance information in the performance table based on the monitored interface performance.

19. The fabric network system of claim 18, wherein the interface performance comprises an internal interface state of an interface of the allocated one or more storage devices and an external interface state of an interface of the host.

20. The fabric network system of claim 16, wherein the controller adjusts the interface performance of the one or more storage devices allocated to the host so that the monitored interface performance satisfies a QoS performance of the host indicated by the QoS information received from the host.
